(19) United States
(12) Patent Application Publication
(10) Pub. No.: US 2017/0168553 A1
(43) Pub. Date: Jun. 15, 2017

(54) DRIVE CONTROL DEVICE

(71) Applicants: INVENTEC TECHNOLOGY CO., LTD, Shanghai (CN); INVENTEC CORPORATION, Taibei City (TW)

(72) Inventor: Kangheng FU, Shanghai (CN)

(73) Assignees: INVENTEC TECHNOLOGY CO., LTD, Shanghai (CN); INVENTEC CORPORATION, Taibei City (TW)

(21) Appl. No.: 15/209,393

(22) Filed: Jul. 13, 2016

(30) Foreign Application Priority Data
Dec. 15, 2015 (CN) 201510939194.6

(51) Int. Cl. G06F 1/32; G06F 9/44; G06F 1/26

(52) U.S. Cl. CPC G06F 1/3296; G06F 1/266; G06F 9/442; G06F 9/4403

(57) ABSTRACT

A drive control device, which includes a control module generating an optical driver power supply control signal; a detection module detecting a working state of an optical driver according to the optical driver power supply control signal or receiving an external input signal and generating a switch control signal according to a detection result or the external input signal; and an execution module electrically connected with the detection module and powering on or off power supply on the optical driver according to the switch control signal. The powering-on and powering-off of the optical driver are flexibly controlled, the situation of increase of additional power consumption of a device for a reason that the optical driver is in a standby state for a long time is avoided.

### BACKGROUND OF THE PRESENT INVENTION

### Field of Invention

The present invention relates to the field of drive control, in particular to a drive control device which can allow electronic devices to operate at low power consumption.

### Description of Related Arts

With the increase of requirements on low-power-consumption design, the greater the proportion of the power consumption of an optical driver in the power consumption of an entire electronic system is, the stricter the corresponding requirement on power consumption optimization is. In configurations of servers, desktop computers and notebook computers, the optical driver is not used unless the system is damaged and cannot be started from other starting devices. Otherwise, the optical driver is always in a standby state and the optical driver in the standby state consumes certain energy. Individual users rarely remove the optical drivers to optimize the power consumption. In addition, in data centers or large computer rooms, users cannot self-remove the optical drivers. Even though the optical drivers are removed, great influences may be caused to system recovery. However, large-scale optical driver deployment causes great energy waste, resulting that the operating costs of customers are increased and the market competitiveness is decreased.

### SUMMARY OF THE PRESENT INVENTION

In view of the disadvantages of the prior art, an object of the present invention is to provide a drive control device, which is used for solving the problem that energy consumption is great for a reason that an optical driver is always in a standby state in the prior art.

In order to realize the above-mentioned object and other related objects, the present invention provides a drive control device, which comprises a control module generating an optical driver power supply control signal; a detection module detecting a working state of an optical driver according to the optical driver power supply control signal or receiving an external input signal and generating a switch control signal according to a detection result or the external input signal; and an execution module electrically connected with the detection module and used for powering on or off power supply of the optical driver according to the switch control signal.

In one specific embodiment of the present invention, the switch control signal comprises a powering-on signal or a powering-off signal, and the execution module powering off the power supply of the optical driver according to the powering off signal or is used for powering on the power supply of the optical driver according to the powering-on signal.

In one specific embodiment of the present invention, when the detection module detects that the time of the standby state of the optical driver is greater than a time threshold, the detection module generates the powering off signal.

In one specific embodiment of the present invention, the control module and the detection module are integrated in a baseboard management controller.

In one specific embodiment of the present invention, the control module is integrated in a baseboard management controller and the detection module is integrated in a programmable logic device.

In one specific embodiment of the present invention, the control module is integrated in a baseboard management controller and the detection module is integrated in a basic input and output system.

In one specific embodiment of the present invention, there are a plurality of detection modules, the execution module is used for receiving a plurality of control signals, and when one of the plurality of control signals is a powering-off signal, the power supply of the optical driver is powered off.

In one specific embodiment of the present invention, the powering-on signal is high-level, the powering-off signal is low-level, and when the execution module receives the plurality of control signals, the execution module performs an AND operation on the control signals and powers on or off the power supply of the optical driver according to a result of the AND operation.

In one specific embodiment of the present invention, the execution module comprises an N-type field effect transistor Q1, an N-type field effect transistor Q2, an N-type field effect transistor Q3, a P-type field effect transistor Q4 and an N-type field effect transistor Q5.

In one specific embodiment of the present invention, a grid of the field effect transistor Q1 is used for receiving the control signal and is grounded through a resistor R1, a source of the field effect transistor Q1 is grounded, a drain of the field effect transistor Q1 is connected with a power supply signal through a pull-up resistor R2 and is connected with a grid of the field effect transistor Q2 and a grid of the field effect transistor Q5, a source of the field effect transistor Q2 is grounded, a drain of the field effect transistor Q2 is connected with the power supply signal through a pull-up resistor R3 and is connected with a grid of the field effect transistor Q3, a source of the field effect transistor Q3 is grounded, a drain of the field effect transistor Q3 is connected with the power supply signal through a pull-up resistor R4 and is connected with a grid of the field effect transistor Q4, a source of the field effect transistor Q4 is electrically connected with the power supply signal, and a drain of the field effect transistor Q4 is connected with a drain of the field effect transistor Q5 and is used for outputting an output signal, wherein when the control signal is a switching-on signal, the output signal is the power supply signal to supply power of the optical driver, and when the control signal is a powering-off signal, the output signal is 0 to power off the power supply of the optical driver.

In one specific embodiment of the present invention, the execution module comprises a power distribution switch chip, wherein an enable end of the power distribution switch chip is used for receiving the control signal and is grounded through a resistor R1, an input end of the power distribution switch chip is connected with a power supply signal and is grounded through a capacitor C1, and an output end of the power distribution switch chip is used for outputting an output signal and is grounded through a resistor R2, wherein when the control signal is a powering-on signal, the power distribution switch chip is enabled and output the power supply signal through the output end to supply power of the optical driver; and when the control signal is a powering-off signal, the power distribution switch chip does not work and the output signal is 0 to power off the power supply of the optical driver.

As described above, the drive control device provided by the present invention comprises the control module generating the optical driver power supply control signal; the detection module detecting the working state of the optical driver according to the optical driver power supply control signal or receiving the external input signal and generating the switch control signal according to the detection result or the external input signal; and the execution module electrically connected with the detection module and used for powering on or off the power supply of the optical driver according to the switch control signal. By flexibly controlling the powering-on and powering off of the optical driver, the situation of increase of additional power consumption of the device for the reason that the optical driver is in the standby state for a long time is avoided.

### BRIEF DESCRIPTION OF THE DRAWINGS

FIG. 1 illustrates a schematic diagram of an application of a drive control device of the present invention in one specific embodiment.

FIG. 2 illustrates a schematic circuit diagram of an execution module in one specific embodiment of the present invention.

FIG. 3 illustrates a schematic circuit diagram of an execution module in one specific embodiment of the present invention.

### DESCRIPTION OF COMPONENT MARK NUMBERS

1 Drive control device

11 Control module

12 Detection module

13 Execution module

2 Optical driver

### DETAILED DESCRIPTION OF THE PREFERRED EMBODIMENTS

The implementation mode of the present invention will be described below in through specific embodiments. One skilled in the art can easily understand other advantages and effects of the present invention according to contents disclosed by the description. The present invention can also be implemented or applied through other different specific implementation modes. Various modifications or changes can also be made to all details in the description based on different points of view and applications without departing from the spirit of the present invention. It needs to be stated that the following embodiments and the features in the embodiments can be combined with one another under the situation of no conflict.

It needs to be stated that the drawings provided in the following embodiments are just used for schematically describing the basic concept of the present invention, thus only illustrate components only related to the present invention and are not drawn according to the numbers, shapes and sizes of components during actual implementation, the configuration, number and scale of each component during actual implementation thereof may be freely changed, and the component layout configuration thereof may be more complex.

By flexibly controlling the powering-on and powering-off of an optical driver, the power consumption of an electronic device comprising an optical driver can be better optimized, and the electronic device is, for example, a server or a computer with an optical driver. By adding an optimization circuit which intelligently controls the optical driver in the existing electronic device, the present invention can further reduce the power consumption of the electronic device.

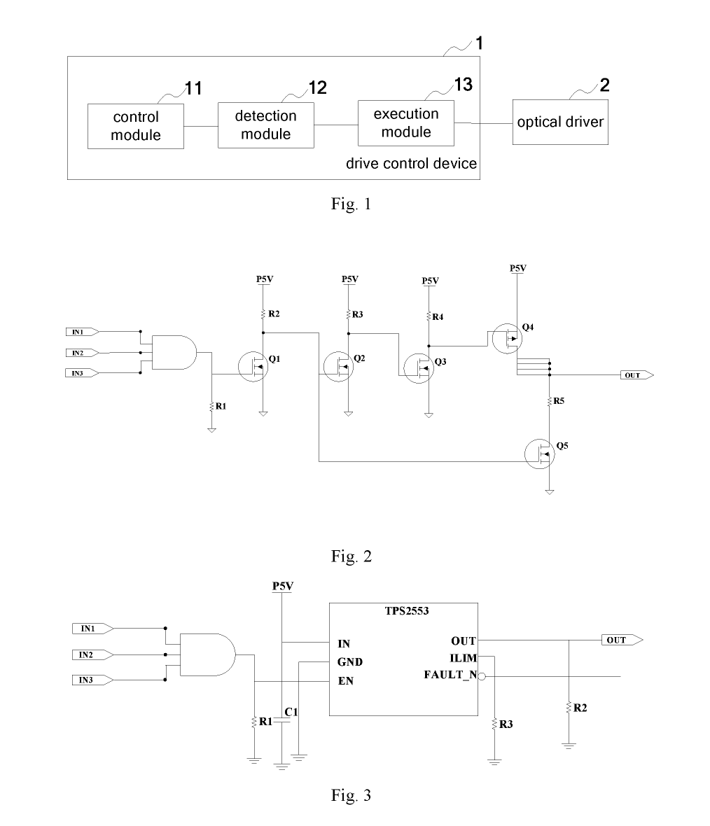

Please refer to FIG. 1, which illustrates a schematic diagram of an application of a drive control device of the present invention in one specific embodiment. The drive control device 1 is applied in an electronic device with an optical driver 2. The drive control device 1 comprises a control module 11, a detection module 12 and an execution module 13.

The control module 11 is used for generating an optical driver 2 power supply control signal.

The detection module 12 is used for detecting a working state of the optical driver according to the optical driver 2 power supply control signal or receiving an external input signal, and generating a switch control signal according to a detection result or the external input signal.

The execution module 13 is electrically connected with the detection module 12 and used for switching on or off power supply on the optical driver 2 according to the switch control signal.

In one specific embodiment of the present invention, the switch control signal comprises a powering-on signal or a powering-off signal, and the execution module 13 is used for powering off the power supply of the optical driver 2 according to the powering-off signal or is used for powering on the power supply of the optical driver 2 according to the powering-on signal.

In one specific embodiment of the present invention, when the detection module 12 detects that the time of the standby state of the optical driver 2 is greater than a time threshold, the detection module generates the powering-off signal; or in another embodiment, when the detection module 12 detects that the electronic device needs to start by using the optical driver 2, the detection module 12 generates the powering-on signal.

In one specific embodiment of the present invention, the control module 11 and the detection module 12 are integrated in a baseboard management controller.

In one specific embodiment of the present invention, the control module 11 is integrated in a baseboard management controller and the detection module 12 is integrated in a programmable logic device.

In one specific embodiment of the present invention, the control module 11 is integrated in a baseboard management controller and the detection module 12 is integrated in a basic input and output system.

In one specific embodiment of the present invention, the external input signal is a signal which makes the optical driver 2 to be manually powered on or off according to the needs of a user.

In one specific embodiment of the present invention, there are a plurality of detection modules 12, the execution module 13 is used for receiving a plurality of control signals, and when one of the plurality of control signals is a powering-off signal, the power supply of the optical driver 2 is powered off. Preferably, the plurality of control signals are respectively transmitted by the baseboard management controller, the basic input and output system or the programmable logic device. In addition, as long as one of the transmitted control signals is a signal which makes the optical driver 2 to be powered on or off, correspondingly the optical driver 2 is enabled to execute a powering-on or powering-off action.

In one specific embodiment of the present invention, the powering-on signal is high-level, the powering-off signal is low-level, and when the execution module receives the plurality of control signals, the execution module performs an AND operation on the control signals and powers on or off the power supply of the optical driver 2 according to a result of the AND operation.

Further refer to FIG. 2, which illustrates a schematic circuit diagram of an execution module in one specific embodiment of the present invention. The execution module 13 comprises an N-type field effect transistor Q1, an N-type field effect transistor Q2, an N-type field effect transistor Q3, a P-type field effect transistor Q4 and an N-type field effect transistor Q5.

In one specific embodiment of the present invention, a grid of the field effect transistor Q1 is used for receiving the control signals and is grounded through a resistor R1. In this embodiment, the number of the control signals is three, and the three control signals are respectively IN1, IN2 and IN3 as shown in the figure and are respectively transmitted by the baseboard management controller, the basic input and output system or the programmable logic device. A source of the field effect transistor Q1 is grounded, a drain of the field effect transistor Q1 is connected with a power supply signal through a pull-up resistor R2 and is connected with a grid of the field effect transistor Q2 and a grid of the field effect transistor Q5, a source of the field effect transistor Q2 is grounded, a drain of the field effect transistor Q2 is connected with the power supply signal through a pull-up resistor R3 and is connected with a grid of the field effect transistor Q3, a source of the field effect transistor Q3 is grounded, a drain of the field effect transistor Q3 is connected with the power supply signal through a pull-up resistor R4 and is connected with a grid of the field effect transistor Q4, a source of the field effect transistor Q4 is electrically connected with the power supply signal, and a drain of the field effect transistor Q4 is connected with a drain of the field effect transistor Q5 and is used for outputting an output signal, wherein when the control signal is a powering-on signal, the output signal is the power supply signal to supply power of the optical driver 2, and when the control signal is a powering-off signal, the output signal is 0 to power off the power supply of the optical driver 2.

Further refer to FIG. 3, which illustrates a schematic circuit diagram of an execution module in one specific embodiment of the present invention. The execution module 13 comprises a power distribution switch chip, wherein an enable end of the power distribution switch chip is used for receiving the control signal and is grounded through a resistor R1. In this embodiment, the number of the control signals is three, and the three control signals are respectively IN1, IN2 and IN3 as shown in the figure and are respectively transmitted by the baseboard management controller, the basic input and output system or the programmable logic device. An input end of the power distribution switch chip is connected with a power supply signal and is grounded through a capacitor C1, and an output end of the power distribution switch chip is used for outputting an output signal and is grounded through a resistor R2, wherein when the control signal is a powering-on signal, the power distribution switch chip is enabled and output the power supply signal through the output end to supply power of the optical driver 2; and when the control signal is a powering-off signal, the power distribution switch chip does not work and the output signal is 0 to power off the power supply of the optical driver 2. In the present embodiment, the power distribution switch chip is a TPS2553 chip. Of course, in other embodiments, the power distribution switch chip can also be one of chips with similar functions and a related circuit can be correspondingly adjusted according to the different models of the chips.

In another specific embodiment of the present invention, the present invention further provides an electronic device, which comprises the drive control device 1 and the optical driver 2 as shown in FIG. 1, the drive control device 1 is applied to control the optical driver 2, and the embodiments as shown in both FIG. 2 and FIG. 3 can be applied to this embodiment, and preferably, the electronic device is, for example, a server or a smart device such as a computer.

In summary, the drive control device provided by the present invention comprises the control module generating the optical driver power supply control signal; the detection module detecting the working state of the optical driver according to the optical driver power supply control signal or receiving the external input signal and generating the switch control signal according to the detection result or the external input signal; and the execution module electrically connected with the detection module and used for powering on or off the power supply of the optical driver according to the switch control signal. By flexibly controlling the powering-on and powering-off of the optical driver, the situation of increase of additional power consumption of the device for the reason that the optical driver is in the standby state for a long time is avoided. Therefore, the present invention effectively overcomes various disadvantages in the prior art and has a great industrial utilization value.

The above-mentioned embodiments are just used for exemplarily describing the principle and effects of the present invention instead of limiting the present invention. One skilled in the art can make modifications or changes to the above-mentioned embodiments without going against the spirit and the range of the present invention. Therefore, all equivalent modifications or changes made by those who have common knowledge in the art without departing from the spirit and technical concept disclosed by the present invention shall be still covered by the claims of the present invention.

1. A drive control device, comprising:
a control module, generating an optical driver power supply control signal;
a detection module, detecting a working state of an optical driver or receiving an external input signal according to the optical driver power supply control signal, and generating a switch control signal according to a detection result or the external input signal; and
an execution module, electrically connected with the detection module and used for powering on or off power supply on the optical driver according to the switch control signal.

2. The drive control device according to claim 1, wherein the switch control signal comprises a powering-on signal or a powering-off signal, and the execution module powering off the power supply on the optical driver according to the powering-off signal or is used for powering on the power supply on the optical driver according to the powering-on signal.

3. The drive control device according to claim 2, wherein when the detection module detects that the time of the standby state of the optical driver is greater than a time threshold, the detection module generates the powering-off signal.

4. The drive control device according to claim 2, wherein the control module and the detection module are integrated in a baseboard management controller.

5. The drive control device according to claim 2, wherein the control module is integrated in a baseboard management controller and the detection module is integrated in a programmable logic device.

6. The drive control device according to claim 2, wherein the control module is integrated in a baseboard management controller and the detection module is integrated in a basic input and output system.

7. The drive control device according to claim 2, wherein there are a plurality of detection modules, the execution module is used for receiving a plurality of control signals, and when one of the plurality of control signals is a powering-off signal, the power supply of the optical driver is powered off.

8. The drive control device according to claim 7, wherein the powering-on signal is high-level, the powering-off signal is low-level, and when the execution module receives the plurality of control signals, the execution module performs an AND operation on the control signals and power on or off the power supply of the optical driver according to a result of the AND operation.

9. The drive control device according to claim 2, wherein the execution module comprises an N-type field effect transistor Q1, an N-type field effect transistor Q2, an N-type field effect transistor Q3, a P-type field effect transistor Q4 and an N-type field effect transistor Q5.

10. The drive control device according to claim 9, wherein a grid of the field effect transistor Q1 is used for receiving the control signal and is grounded through a resistor R1, a source of the field effect transistor Q1 is grounded, a drain of the field effect transistor Q1 is connected with a power supply signal through a pull-up resistor R2 and is connected with a grid of the field effect transistor Q2 and a grid of the field effect transistor Q5, a source of the field effect transistor Q2 is grounded, a drain of the field effect transistor Q2 is connected with the power supply signal through a pull-up resistor R3 and is connected with a grid of the field effect transistor Q3, a source of the field effect transistor Q3 is grounded, a drain of the field effect transistor Q3 is connected with the power supply signal through a pull-up resistor R4 and is connected with a grid of the field effect transistor Q4, a source of the field effect transistor Q4 is electrically connected with the power supply signal, and a drain of the field effect transistor Q4 is connected with a drain of the field effect transistor Q5 and is used for outputting an output signal, wherein when the control signal is a powering-on signal, the output signal is the power supply signal to supply power of the optical driver, and when the control signal is a powering-off signal, the output signal is 0 to power off the power supply of the optical driver.

11. The drive control device according to claim 2, wherein the execution module comprises a power distribution switch chip, wherein an enable end of the power distribution switch chip is used for receiving the control signal and is grounded through a resistor R1, an input end of the power distribution switch chip is connected with a power supply signal and is grounded through a capacitor C1, and an output end of the power distribution switch chip is used for outputting an output signal and is grounded through a resistor R2; wherein when the control signal is a powering-on signal, the power distribution switch chip is enabled and output the power supply signal through the output end to supply power of the optical driver; and when the control signal is a powering-off signal, the power distribution switch chip does not work and the output signal is 0 to switch off the power supply of the optical driver.
